(19) United States
(12) Patent Application Publication
(10) Pub. No.: US 2016/0322664 A1
(43) Pub. Date: Nov. 3, 2016

(54) APPARATUS AND METHOD FOR FASTENING FUEL CELL STACK

(71) Applicant: Hyundai Motor Company, Seoul (KR)

(72) Inventors: Joo Ok Park, Ulsan (KR); Ji Won Yu, Ulsan (KR)

(21) Appl. No.: 14/944,375

(22) Filed: Nov. 18, 2015

(30) Foreign Application Priority Data
Apr. 29, 2015 (KR) 10-2015-0060562

(51) Int. Cl. H01M 8/2404; B60K 6/32; B60L 11/18; F16B 2/10; F16B 2/12

(52) U.S. Cl. CPC H01M 8/2404; F16B 2/10; F16B 2/12; B60L 11/1881; B60K 6/32; B60Y 2200/92; B60Y 2400/11

(57) ABSTRACT

An apparatus and method are provided for fastening a fuel cell stack capable of significantly enhancing assembly characteristics and productivity of a stack by preventing insulating plates, when assembled, from being interfered or hampered by other components, while maintaining the stack pressed with appropriate pressure applied thereto. The apparatus includes a loading jig into which a stack is loaded and a press block that is configured to press the stack. Additionally, a pressing maintaining unit is configured to maintain the stack in a pressed state by the press block.

### CROSS-REFERENCE TO RELATED APPLICATION

This application is based on and claims the benefit of priority to Korean Patent Application No. 10-2015-0060562, filed on Apr. 29, 2015, in the Korean Intellectual Property Office, the disclosure of which is incorporated herein in its entirety by reference.

### TECHNICAL FIELD

The present disclosure relates to an apparatus for fastening a fuel cell stack and, more particularly, to an apparatus and method for fastening a fuel cell stack, capable of preventing insulating plates, when assembled, from being interfered or hampered by other component, while maintaining a stack pressed with appropriate pressure applied thereto, thereby significantly enhancing assembly characteristics and productivity of the stack.

### BACKGROUND

Recently, fuel cells are being studied as an energy source for vehicles to reduce environment pollution. In particular, fuel cells are an energy source obtaining electric energy from an electrochemical reaction between hydrogen or hydrocarbon-based fuels and an oxidizing agent represented by oxygen. A fuel cell includes a stack that produces electricity, a fuel supply part configured to supply fuel to the stack, and an oxidizing agent supply part configured to supply an oxidizing agent (e.g., air) to the stack. Particularly, the stack has a structure in which membrane electrode assemblies and separators are sequentially stacked, and the membrane electrode assemblies produce electricity through an oxidation of fuel and a reducing reaction of a reducing agent.

Further, unit cells divided by separators are sequentially stacked, and output voltages of the unit cells are summed to define an output voltage of the stack. Performance of the stack may be evaluated by a magnitude of the aforementioned output voltage, and the output voltage is affected by pressure between the separators. The separators of the stack are formed of graphite, a metal, or a composite material, and are configured to prevent leakage of fuel for an electrochemical reaction through a gasket.

Hydrogen passing through a gas flow channel formed on one surface of a separator is supplied to the film electrode assemblies through a gas diffusion layer and chemically reacts to oxygen supplied from the other surface of the separator, generating current. To determine efficiency of the stack, strength of current output through electrodes formed at both ends of each separate has been used and contact pressure between the separators affect the strength of the current. In other words, when contact pressure is insufficient, contact resistance between the separators may be increased which prevents the current from flowing, and when the contact pressure is excessive, the gas diffusion layer may be compressed which results in ineffective gas diffusion.

Thus, predetermined contact pressure at which generated current has the most appropriate strength has been determined, and the contact pressure is adjusted by providing a fastening apparatus to an exterior of a fuel cell stack. Such an apparatus for fastening a fuel cell stack includes a base supporting a lower end of a stack, a pressing plate pressing an upper end of the stack, and a guide mechanism configured to guide a movement of the pressing plate. With this configuration, when the upper end of the stack is pressed by the pressing plate, air-tightness of the stack is inspected, and thereafter, insulating plates are coupled to front and rear surfaces of the stack by fastening bars, thereby completing assembling of the fuel cell stack.

However, in the related art apparatus for fastening the stack, when the insulating plates are coupled to the front and rear surfaces of the stack when the stack is pressed, it may be difficult to assemble the insulating plates due to interference of other components such as a guide, or the like, and, in addition, alignment of the stack may be degraded, deteriorating productivity and quality.

### SUMMARY

The present disclosure provides an apparatus and method for fastening a fuel cell stack, capable of significantly enhancing assembly characteristics and productivity of a stack by preventing insulating plates, when assembled, from being interfered or hampered by other components, while maintaining the stack pressed with appropriate pressure applied thereto, and capable of enhancing quality by increasing alignment of the stack.

According to an exemplary embodiment of the present disclosure, an apparatus for fastening a fuel cell stack may include: a loading jig in which a stack may be loaded; a press block configured to press the stack; and a pressing maintaining unit configured to maintain the stack pressed by the press block (e.g., maintain the pressure applied thereto).

The press block may be installed to be movable up and down (e.g., vertically) and rotatable about a vertical axial line. The loading jig may include an upper frame having an opening, a lower support block spaced apart from the upper frame below the upper frame, and a plurality of alignment guides disposed between the upper frame and the lower support block. The pressing maintaining unit may include a first pressing maintaining plate disposed on a lower end of the press block, a second pressing maintaining plate disposed on a lower support block of the loading jig, and support rods separably (e.g., with possibility of separation) connecting the first pressing maintaining plate and the second pressing maintaining plate.

The first pressing maintaining plate may be disposed on the lower end of the press block to press against an upper end of the stack loaded within the loading jig based on a downward movement of the press block. The second pressing maintaining plate may be disposed to be movable up and down (e.g., vertically) on the lower support block of the loading jig to support a lower surface of the stack.

A recess portion allowing the second pressing maintaining plate to be mounted thereon may be disposed on an upper surface of the lower support block. When the second pressing maintaining plate is mounted on the recess portion of the lower support block, an upper surface of the second pressing maintaining plate may be coplanar with an upper surface of the lower support block. An upper end of each of the support rods may be integrally fixed to the first pressing maintaining plate, and a lower end of each of the support rods may be separably coupled to the second pressing maintaining plate.

A coupling end may be provided at a lower end of each of the support rods, and separably coupled to the second pressing maintaining plate. The coupling end may be formed at the lower end of each support rod, a coupling aperture may be formed at the coupling end, and a plurality of through holes may be formed at positions of the second pressing maintaining plate which correspond to the support rods, and in a state in which the coupling end of each of the support rods is able to protrude downwardly by penetrating through the through holes, a coupling pin may be coupled to the coupling aperture of the coupling end, whereby the coupling end of each of the support rods may be coupled to the second pressing maintaining plate.

According to another exemplary embodiment of the present disclosure, an apparatus for fastening a fuel cell stack may include: a base; an upper plate spaced apart from the base above the base; a loading jig mounted on the base and configured to receive a stack therein; a press block configured to press the stack loaded (e.g., received therein) in the loading jig; a driving unit configured to move the press block vertically and rotate the press block about a vertical axial line; and a pressing maintaining unit configured to maintain the stack a pressed state.

A support guide may be installed to extend in a vertical direction between the base and the upper plate, and the press block may be guided in a vertical movement by the support guide. The loading jig may include an upper frame having an opening, a lower support block spaced apart from the upper frame below the upper frame, and a plurality of alignment guides disposed between the upper frame and the lower support block. A mounting part may be disposed on an upper surface of the base, and the lower support block of the loading jig may be mounted on an upper surface of the mounting part.

A positioning recess and a positioning protrusion may be formed to correspond to each other on a lower surface of the lower support block and on an upper surface of the mounting part, respectively. The pressing maintaining unit may include a first pressing maintaining plate disposed on a lower end of the press block, a second pressing maintaining plate disposed on a lower support block of the loading jig, and support rods separably connecting the first pressing maintaining plate and the second pressing maintaining plate. An upper end of the support rod may be integrally fixed to the first pressing maintaining plate, and a lower end of the support rod may be separably coupled to the second pressing maintaining plate.

According to another exemplary embodiment of the present disclosure, a method for fastening a fuel cell stack to assemble the fuel cell stack may include: loading a stack in a loading jig; pressing the stack loaded in the loading jig; maintaining the stack in a pressed state; moving the stack upwardly when the stack is maintained in a pressed state, to separate the stack from the loading jig; and assembling a front insulating plate and a rear insulating plate to a front surface and a rear surface of the stack separated from the loading jig upwardly, respectively. The method may further include rotating the stack at a predetermined angle about a vertical axial line, between the stack separating operation and the insulating plate assembling operation.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating an apparatus for fastening a fuel cell stack according to an exemplary embodiment of the present disclosure;

FIG. 2 is a front view illustrating the apparatus for fastening a fuel cell stack according to an exemplary embodiment of the present disclosure;

FIG. 3 is a view illustrating a loading jig of the apparatus for fastening a fuel cell stack according to an exemplary embodiment of the present disclosure;

FIG. 4 is a view illustrating an assembly relationship of the loading jig and a mounting part of the apparatus for fastening a fuel cell stack according to an exemplary embodiment of the present disclosure;

FIG. 5 is a detailed view illustrating a state before a lower end of a support rod and a second pressing maintaining plate of a pressing maintaining unit of the apparatus for fastening a fuel cell stack according to an exemplary embodiment of the present disclosure are coupled;

FIG. 6 is a view illustrating a state in which the lower end of the support rod and the second pressing maintaining plate of the pressing maintaining unit of the apparatus for fastening a fuel cell stack according to an exemplary embodiment of the present disclosure are coupled by a coupling pin;

FIG. 7 is a view illustrating a state in which the stack is maintained to be pressed by the pressing maintaining unit of the apparatus for fastening a fuel cell stack according to an exemplary embodiment of the present disclosure;

FIGS. 8A-8C are views illustrating loading a stack, applying a jig, performing pressing, and inspecting air-tightness using the apparatus for fastening a fuel cell stack according to an exemplary embodiment of the present disclosure;

FIGS. 9A-9C are views illustrating coupling of a coupling pin of the pressing maintaining unit, lifting a stack, and inserting an insulating plate by using the apparatus for fastening a fuel cell stack according to an exemplary embodiment of the present disclosure;

FIGS. 10A-10C are views illustrating assembling a front insulating plate to a front surface of the stack using a front fastening bar, assembling a rear insulating plate to a rear surface of the stack using a rear fastening bar, and lowering the stack using the apparatus for fastening a fuel cell stack according to an exemplary embodiment of the present disclosure;

FIGS. 11A-11B are views illustrating releasing of a coupling pin of the pressing maintaining unit, unloading the stack, and returning the loading jig by using the apparatus for fastening a fuel cell stack according to an exemplary embodiment of the present disclosure; and

FIG. 12 is a detailed view illustrating a process of assembling the front insulating plate and the rear insulating plate to the front and rear surfaces of the stack by the front and rear fastening bars, respectively.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiment of the present disclosure will be described in detail with reference to the accompanying drawings. For reference, dimensions of elements or thicknesses of lines illustrated in the drawings are referred to describe the present disclosure may be exaggerated for the convenience of understanding. Also, the terms used henceforth have been defined in consideration of the functions of the present disclosure, and may be altered according to the intent of a user or operator, or conventional practice. Therefore, the terms should be defined on the basis of the entire content of this specification.

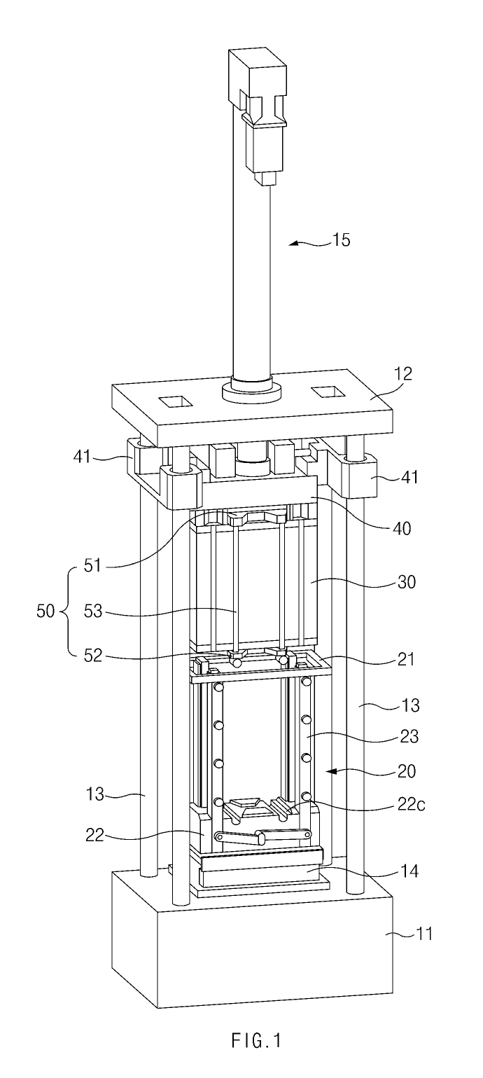

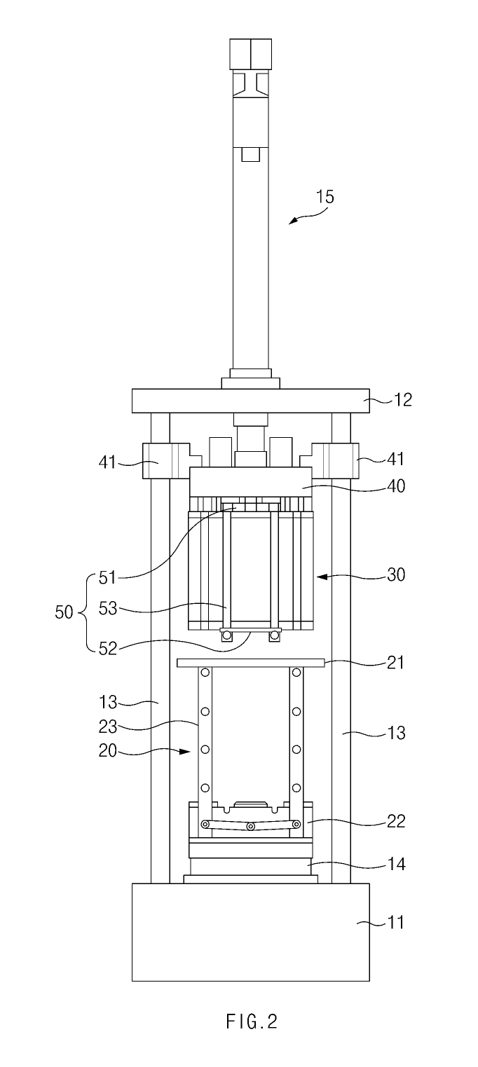

FIG. 1 is a view illustrating an apparatus for fastening a fuel cell stack according to an exemplary embodiment of the present disclosure. As illustrated in FIGS. 1 and 2, the apparatus for fastening a fuel cell stack according to an exemplary embodiment of the present disclosure may include a loading jig 20 in which a stack 30 may be loaded (e.g., received), a press block 40 configured to press (e.g., apply or exert pressure to) an upper end of the stack 30 loaded in the loading jig 20, and a pressing maintaining unit 50 configured to maintain a pressed state of the stack 30 after the stack 30 is pressed by the press block 40.

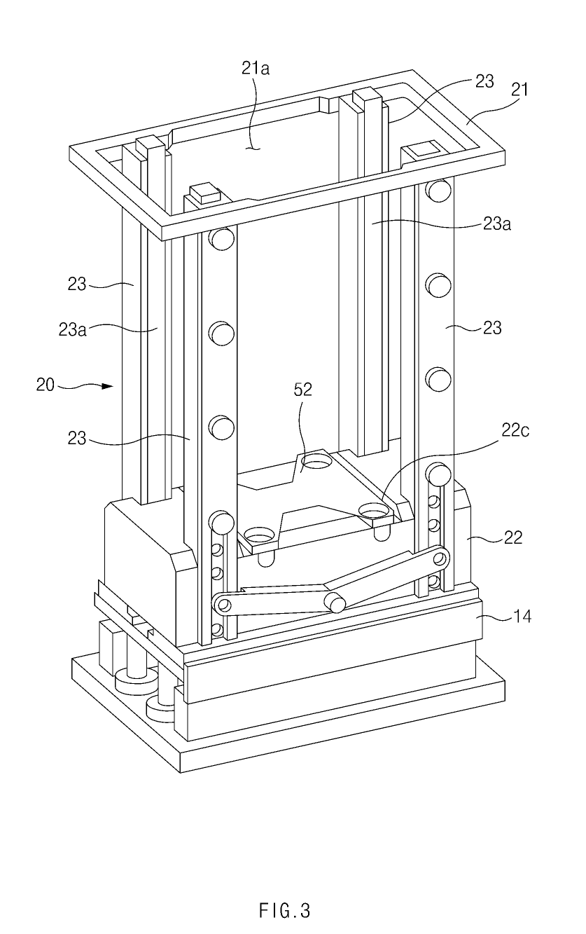

As illustrated in FIG. 3, the loading jig 20 may include an upper frame 21 having an opening 21a, a lower support block 22 spaced apart from the upper frame 21 below the upper frame 21, and a plurality of alignment guides 23 disposed between the upper frame 21 and the lower support block 22.

The upper frame 21 may have a substantially quadrangular frame structure with the opening 21a, and the stack 30 may be inserted through the opening 21a of the upper frame 21. The lower support block 22 may be mounted on a base 11, and a recess portion 22c on which a second pressing maintaining plate 52 is mounted (to be described hereinafter) may be disposed on an upper surface of the lower support block 22.

In particular, when the second pressing maintaining plate 52 is mounted on the recess portion 22c of the lower support block 22, an upper surface of the second pressing maintaining plate 52 may be maintained to be coplanar with an upper surface of the lower support block 22. Since the upper surface of the second pressing maintaining plate 52 and the upper surface of the lower support block 22 may be positioned to be coplanar, a lower surface of the stack 30 may be supported on the lower support block 22.

The alignment guide 23 may be installed to connect the upper frame 21 and the lower support block 22 in a vertical direction, and in particular, a plurality of alignment guides 23 may be configured to align the stack 30 inserted through the opening 21a of the upper frame 21, as illustrated in FIG. 3. For example, two alignment guides may be disposed at a front side to align a front surface of the stack 30 and two alignment guides may be disposed at a rear side to align a rear surface of the stack 30. Each of the alignment guides 23 may have alignment surfaces 23a that extend in a length direction to align the front surfaces and rear surfaces of the stack 30.

Accordingly, the stack 30 may be loaded through the opening 21a of the upper frame 21 to be supported on the lower support block 22. Since the stack 30 may be more accurately aligned in the front and rear surfaces by the alignment surfaces 23a of the alignment guides 23, assembly precision of the stack 30 may be considerably enhanced.

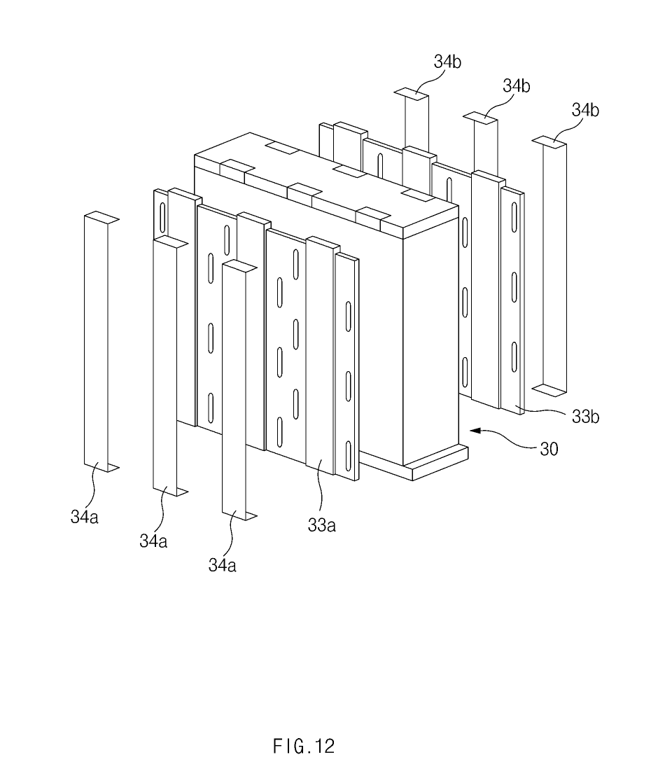

Furthermore, the stack 30 loaded in the loading jig 20 may be formed by sequentially stacking a plurality of unit cells divided by a separator. The stack 30 loaded in the loading jig 20 may be pressed by pressure (e.g., pressure may be exerted onto the stack 30) to secure air-tightness (e.g., maintain an air-tight seal) as well as maintaining appropriate contact pressure by the press block 40. Thereafter, as illustrated in FIG. 12, a front insulating plate 33a may be coupled to the front surface of the stack 30 by a front fastening bar 34a, and a rear insulating plate 33b may be coupled to the rear surface of the stack 30 by a rear fastening bar 34b, thereby completing assembling of the fuel cell stack.

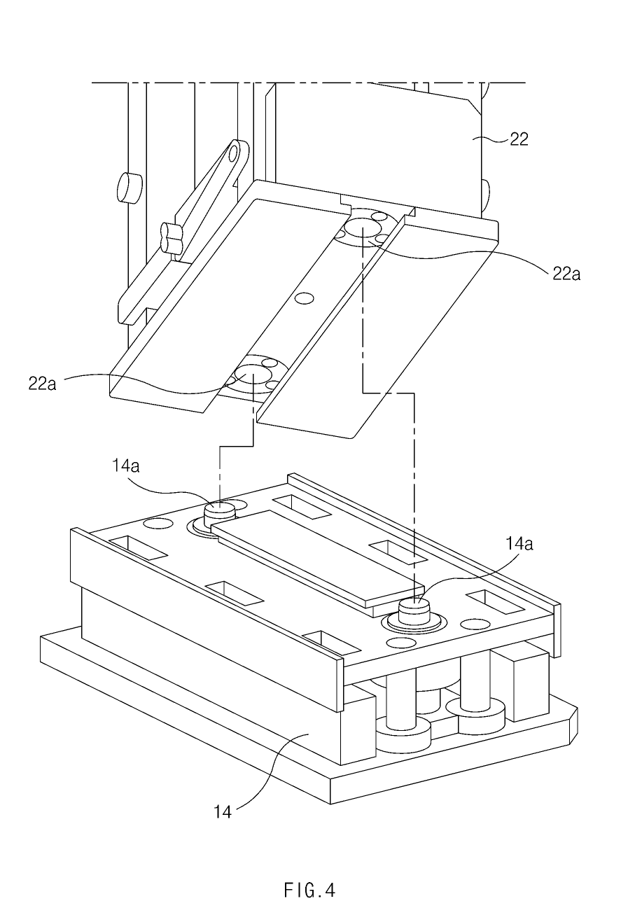

The loading jig 20 may be mounted on the base 11, an upper plate 12 may be spaced apart from the base 11 above the base 11, and a support guide 13 may be extendedly installed in a vertical direction between the base 11 and the upper plate 12. A mounting part 14 may be disposed on an upper surface of the base 11, and as illustrated in FIG. 3, a lower support block 22 of the loading jig 20 may be more accurately mounted on an upper surface of the mounting part 14. In particular, as illustrated in FIG. 4, positioning recesses 22a and positioning protrusions 14a may be formed to correspond to each other on a lower surface of the lower support block 22 and an upper surface of the mounting part 14, respectively, whereby the loading jig 20 may be more accurately mounted on the mounting part 14 of the base 11.

Additionally, a driving unit 15 configured to move the press block 40 in a vertical direction and rotate the press block 40 about a vertical axial line may be installed on the upper plate 12. Accordingly, the press block 40 may be installed to be moved in the vertical direction by the driving unit 15 and rotated about the vertical axial line. In particular, the press block 40, moved downwardly by the driving unit 15, may be configured to press the stack 30 loaded in the loading jig 20 downwardly (from above), whereby the stack 30 may be pressed by appropriate pressure to maintain the pressed state.

A plurality of guide blocks 41 may be symmetrically connected to both sides of the press block 40 and may be guided in a vertical movement through support guides 13. In particular, the support guides 13 may be configured to more stably support the upper plate 12 in the vertical direction with respect to the base 11, as well as to guide the guide block 41. The pressing maintaining unit 50 may be configured to maintain the stack 30 in a pressed state within the loading jig 20 based on a downward movement of the press block 40.

According to an exemplary embodiment, as illustrated in FIGS. 1 through 3, the pressing maintaining unit 50 may include a first pressing maintaining plate 51 disposed on a lower end of the press block 40, a second pressing maintaining plate 52 disposed on the lower support block 22 of the loading jig 20, and a support rod 53 that separately connects the first pressing maintaining plate 51 and the second pressing maintaining plate 52.

The first pressing maintaining plate 51 may be disposed on the lower end of the press block 40 and may be configured to press an upper end of the stack 30 loaded within the loading jig 20 when the press block 40 is moved downwardly by the driving unit 15. The second pressing maintaining plate 52 may be movable to the lower support block 22 of the loading jig 20 to support a lower surface of the stack 30.

Further, the support rod 53 may extend downwardly from the first pressing maintaining plate 51, and in particular, a plurality of support rods 53 may be disposed to stably support the stack 30 pressed between the first pressing maintaining plate 51 and the second pressing maintain plate 52. For example, two support rods 53 may be disposed a front side of the first pressing maintaining plate 51 and two support rods 53 may be disposed a rear side of the first pressing maintaining plate 52.

An upper end of the support rod 53 may be integrally fixed to the first pressing maintaining plate 51, and a lower end of the support rod 53 may be separably coupled to the second pressing maintaining plate 52, whereby the support rod 53 may separably connect the first pressing maintaining plate 51 and the second pressing maintaining plate 52, while uniformly maintaining a space between the first pressing maintaining plate 51 and the second pressing maintaining plate 52.

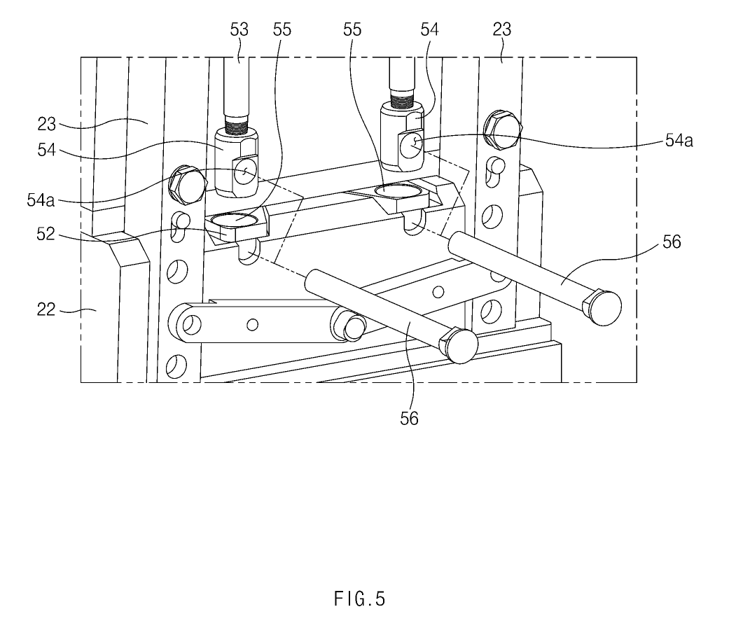

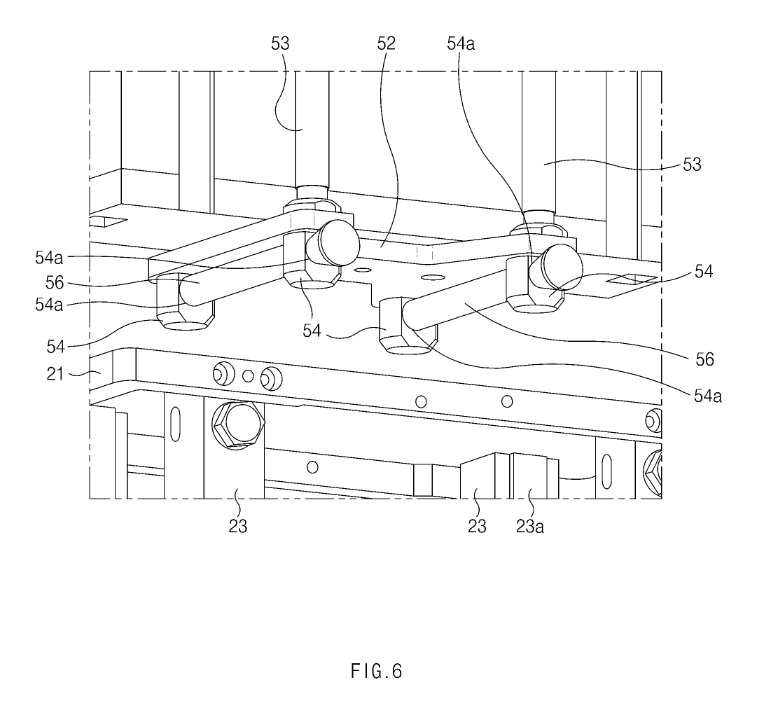

In particular, as illustrated in FIGS. 5 and 6, a coupling end 54 may be disposed on a lower end of the support rod 53, and a coupling aperture 54a configured to receive a coupling pin 56 may be formed on the coupling end 54. A plurality of apertures 55 may be formed at positions corresponding to the second pressing maintaining plate 52 which correspond to the support rods 53, and each of the apertures 55 may be formed in a vertical direction, and the coupling end 54 of the support rod 53 may penetrate through each aperture 55. When the press block 40 moves downwardly toward the stack 30 loaded within the loading jig 20 by the pressing maintaining unit 50, the stack 30 may be pressed with appropriate pressure between the first pressing maintaining plate 51 and the second pressing maintaining plate 52 and the first pressing maintaining plate 51 and the support rod 53, together with the press block 40, may move downwardly.

Accordingly, as illustrated in FIG. 6, the coupling end 54 of each support rod 53 may penetrate through the aperture 55 of the second pressing maintaining plate 52 and may protrude downwardly. When the coupling terminal 54 of each support rod 53 protrudes downwardly from the aperture 55 of the second pressing maintaining plate 52, the coupling pin 56 may be inserted into a coupling aperture 54 of each coupling terminal 54 across the front support rod 51 and the rear support rod 51, whereby the lower end of the support rod 53 may be coupled to the second pressing maintaining plate 52. As the lower end of the support rod 53 is coupled to the second pressing maintaining plate 52, the first pressing maintaining plate 51 may be configured to press the upper end of the stack 30 and the second pressing maintaining plate 52 may be configured to press the lower end of the stack 30, to more stably maintain the stack 30 in a pressed state (e.g., by the press block 40).

After the operation of pressing the stack 30 by the press block 40 and the operation of maintaining the stack 30 pressed by the pressing maintaining unit 50, when the press block 40 moves upwardly, the stack 30 may be released upwardly from the loading jig 20, and in this state, the press block 40 may be rotated at an appropriate angle by the driving unit 15 and the front insulating plate 33a and the rear insulating plate 33b may subsequently be simplified, rapidly assembled to the front and rear surfaces of the stack 30, respectively.

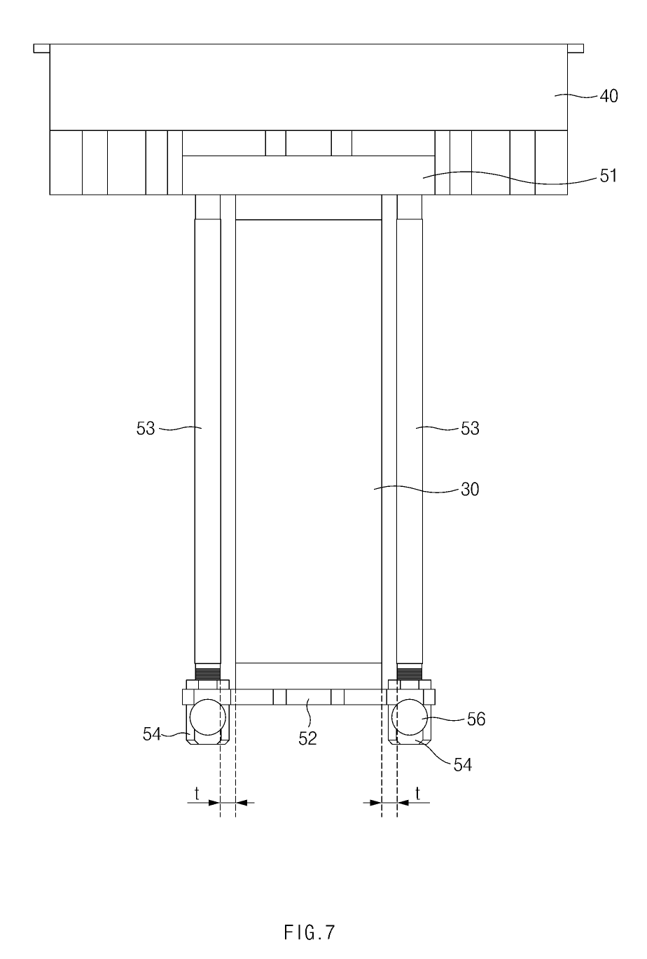

As illustrated in FIG. 7, the support rod 53 may be spaced apart by a predetermined interval t from the front and rear surfaces of the stack 30 maintained to be pressed by the first and second pressing maintaining plates 51 and 52. Since the support rod 53 may be spaced apart by the predetermined interval t from the front and rear surfaces of the stack 30, the support rod 53 does not require separation when the front insulating plate 33a and the rear insulating plate 33b are assembled to the front surface and the rear surface of the stack 30, respectively, and thus, assembly speed (e.g., the time required for assembly) of the insulating plates 33a and 33b may be reduced and simplified, considerably enhancing productivity of the fuel cell stack.

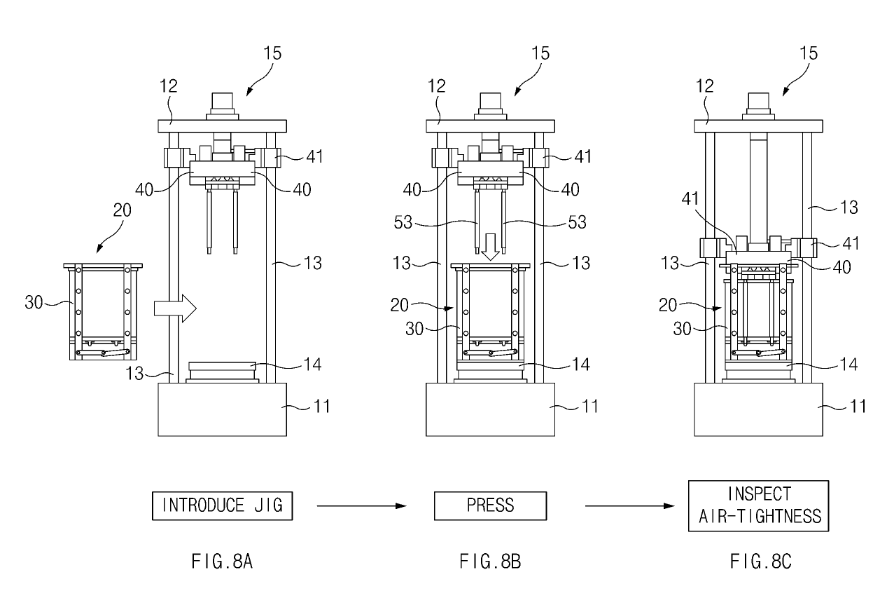

FIGS. 8A through 11B illustrate sequential stages of a method for fastening a fuel cell stack using the fuel cell stack fastening apparatus according to the present disclosure. First, as illustrated in FIG. 8A, a loading jig 20 with the stack 30 loaded therein may be mounted on the mounting part 14 of the base 11. As illustrated in FIG. 8B, with the loading jig 20 mounted on the mounting part 14 of the base 11, the press block 40 may be moved downwardly to press the stack 30 loaded in the loading jig 20 with appropriate pressure, and thereafter, as illustrated in FIG. 8C, air-tightness may be inspected with respect to pressure applied to the stack 30.

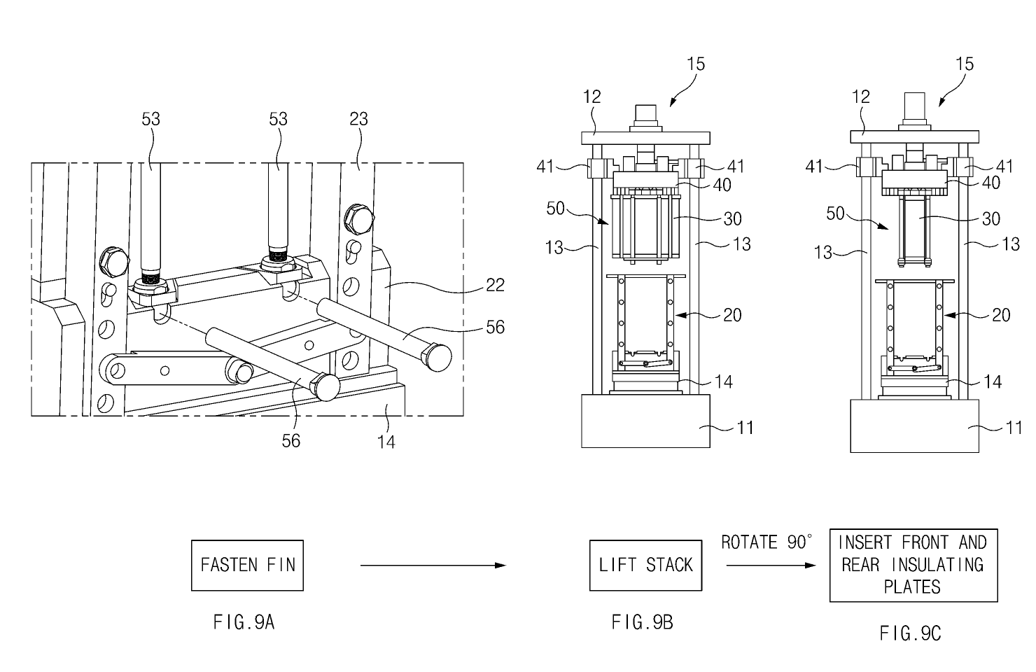

In response to determining that the stack 30 is in a state of being pressed with an appropriate amount of pressure by the press block 40, as illustrated in FIG. 9A, the support rod 53 of the pressing maintaining unit 50 may be coupled to the second pressing maintaining plate 52 by the coupling pin 56 (please refer to FIGS. 5 and 6 for details thereof), whereby the stack 30 in a pressed state between the first pressing maintaining plate 51 and the second pressing maintaining plate 52 may be more stably maintained.

When the stack 30 is maintained in a pressed state by the pressing maintaining unit 50 and the press block 40 is moved upwardly by the driving unit 15 as illustrated in FIG. 9B, the stack 30 may be lifted together with the press block 40 by the pressing maintaining unit 50 to be completely released from the loading jig 20. When the stack 30 is released from the loading jig 20, as illustrated in FIG. 9C, the press block 40 may be rotated by about 90 degrees by the driving unit 15.

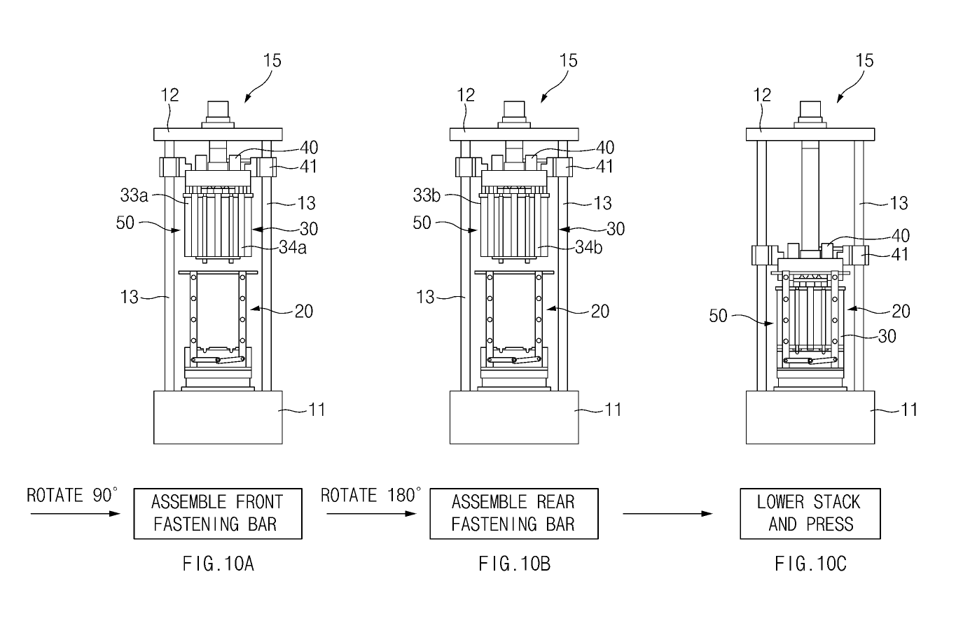

Accordingly, the stack 30 may be rotated by about 90 degrees together with the press block 40, and thus, the front surface and the rear surface of the stack 30 may be sufficiently spaced apart from the support guide 13. In this state, as illustrated in FIG. 12, the front insulating plate 33a and the rear insulating plate 33b may be inserted to the front surface and the rear surface of the stack 30, respectively. Thereafter, as illustrated in FIG. 10A, the press block 40 may be rotated by about 90 degrees reversely to be returned to an original position thereof, and the front fastening bar 34a may be subsequently fastened to the front surface of the stack 30 to assemble the front insulating plate 33a. Thereafter, as illustrated in FIG. 10B, the press block 40 may be rotated by about 180 degrees, and the rear fastening bar 34b may be fastened to the rear surface of the stack 30 to assemble the rear insulating plate 33b.

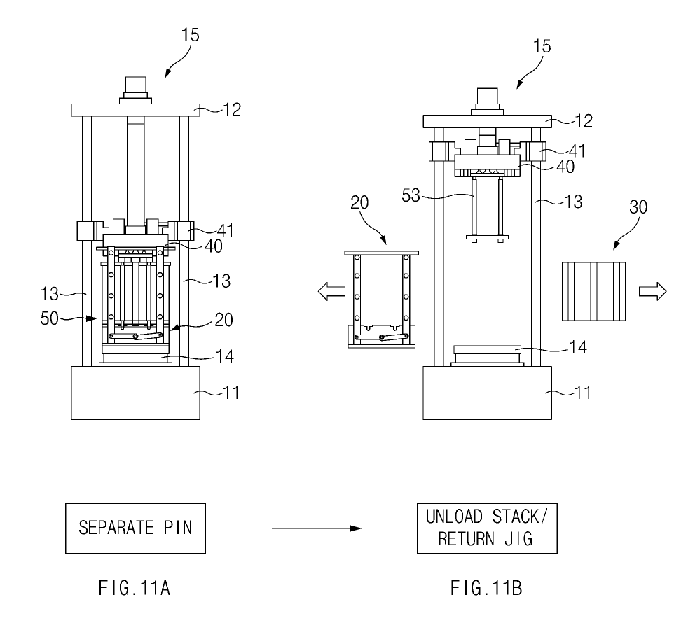

After the front insulating plate 33a and the rear insulating plate 33b are assembled to the front surface and the rear surface of the stack 30, respectively, the press block 40 may be moved downwardly by the driving unit 15 to return the stack 30 to an original position thereof within the loading jig 20 and subsequently press the stack 30, as illustrated in FIG. 10C. Finally, as illustrated in FIGS. 11A and 11B, the coupling pin 56 that couples the support rod 53 and the second pressing maintaining plate 52 of the pressing maintaining unit 50 may be separated, the loading jig 20 and the stack 30 may be separated, the stack 30 may be unloaded, and the loading jig 20 may be subsequently returned to a process of loading a following stack 30.

As described above, according to the exemplary embodiment of the present disclosure, since the insulating plates are not interfered or hampered by other components when assembled, while maintaining the stack pressed with appropriate pressure applied thereto, assembly characteristics and productivity of the stack may be significantly enhanced, and since alignment of the stack is increased, quality may be enhanced. The advantages and effects of the present disclosure are not limited to the aforesaid, and any other advantages and effects not described herein will be clearly understood by those skilled in the art from descriptions of claims.

The present disclosure described above may be variously substituted, altered, and modified by those skilled in the art to which the present disclosure pertains without departing from the scope and spirit of the present disclosure. Therefore, the present disclosure is not limited to the above-mentioned exemplary embodiments and the accompanying drawings.

What is claimed is:

1. An apparatus for fastening a fuel cell stack, comprising:
a loading jig into which a stack is loaded;
a press block configured to apply pressure onto the stack; and
a pressing maintaining unit configured to maintain the stack in a pressed state by the press block.

2. The apparatus according to claim 1, wherein the press block is installed to be vertically movable and rotatable about a vertical axial line.

3. The apparatus according to claim 1, wherein the loading jig includes:
an upper frame having an opening;
a lower support block spaced apart from the upper frame below the upper frame; and
a plurality of alignment guides disposed between the upper frame and the lower support block.

4. The apparatus according to claim 3, wherein the pressing maintaining unit includes:
a first pressing maintaining plate disposed on a lower end of the press block;
a second pressing maintaining plate disposed on the lower support block of the loading jig; and
support rods separably connecting the first pressing maintaining plate and the second pressing maintaining plate.

5. The apparatus according to claim 4, wherein the first pressing maintaining plate is disposed on the lower end of the press block to press an upper end of the stack loaded within the loading jig based on a downward movement of the press block.

6. The apparatus according to claim 4, wherein the second pressing maintaining plate is disposed to be vertically movable on the lower support block of the loading jig to support a lower surface of the stack.

7. The apparatus according to claim 4, wherein a recess portion allowing the second pressing maintaining plate to be mounted thereon is disposed on an upper surface of the lower support block.

8. The apparatus according to claim 7, wherein when the second pressing maintaining plate is mounted on the recess portion of the lower support block, an upper surface of the second pressing maintaining plate is coplanar with the upper surface of the lower support block.

9. The apparatus according to claim 4, wherein an upper end of each of the support rods is integrally fixed to the first pressing maintaining plate, and a lower end of each of the support rods is separably coupled to the second pressing maintaining plate

10. The apparatus according to claim 9, wherein a coupling end is disposed at the lower end of each of the support rods and separably coupled to the second pressing maintaining plate.

11. The apparatus according to claim 10, wherein the coupling end is formed at the lower end of each of the support rods, a coupling aperture is formed at the coupling end, and a plurality of apertures are formed at positions corresponding to the second pressing maintaining plate which correspond to the support rods, and when the coupling end of each support rod is available to protrude downwardly by penetrating through the apertures, a coupling pin is coupled to the coupling aperture of the coupling end, whereby the coupling end of each support rod is coupled to the second pressing maintaining plate.

12. An apparatus for fastening a fuel cell stack, comprising:
a base;
an upper plate spaced apart from the base in a vertical direction;
a loading jig mounted on the base and configured to load a stack therein;
a press block configured to press the stack loaded in the loading jig;
a driving unit configured to move the press block vertically and rotate the press block about a vertical axial line; and
a pressing maintaining unit configured to maintain the stack in a pressed state by the press block.

13. The apparatus according to claim 12, wherein a support guide is installed to extend in a vertical direction between the base and the upper plate, and the press block is guided in a vertical movement by the support guide.

14. The apparatus according to claim 12, wherein the loading jig includes:
an upper frame having an opening;
a lower support block spaced apart from the upper frame below the upper frame; and
a plurality of alignment guides disposed between the upper frame and the lower support block.

15. The apparatus according to claim 14, wherein a mounting part is disposed on an upper surface of the base, and the lower support block of the loading jig is mounted on an upper surface of the mounting part.

16. The apparatus according to claim 15, wherein a positioning recess and a positioning protrusion are formed to correspond to each other on a lower surface of the lower support block and on the upper surface of the mounting part, respectively.

17. The apparatus according to claim 12, wherein the pressing maintaining unit includes:
a first pressing maintaining plate disposed on a lower end of the press block;
a second pressing maintaining plate disposed on a lower support block of the loading jig; and
support rods separably connecting the first pressing maintaining plate and the second pressing maintaining plate.

18. The apparatus according to claim 17, wherein an upper end of the support rod is integrally fixed to the first pressing maintaining plate, and a lower end of the support rod is separably coupled to the second pressing maintaining plate.

19. A method for fastening a fuel cell stack, comprising:
loading a stack into a loading jig;
pressing the stack loaded in the loading jig;
maintaining the stack in a pressed state by applying pressure thereto;
moving the stack upwardly when the stack is maintained in the pressed state, to separate the stack from the loading jig; and
assembling a front insulating plate and a rear insulating plate to a front surface and a rear surface of the stack separated from the loading jig upwardly, respectively.

20. The method according to claim 19, further comprising:
rotating the stack at a predetermined angle about a vertical axial line, between the stack separating operation and the insulating plate assembling operation.
